(19) United States
(12) Patent Application Publication
(10) Pub. No.: US 2009/0151145 A1
(43) Pub. Date: Jun. 18, 2009

(54) PROCESS FOR MOULDING A PORTION OF A HOLLOW COMPONENT AND METHOD OF FASTENING IT TO A FUEL TANK

(75) Inventors: Simon Bousquet, Amberieu en Bugey (FR); Jules-Joseph Van Schaftingen, Wavre (BE)

Correspondence Address: OBLON, SPIVAK, MCCLELLAND MAIER & NEUSTADT, P.C., 1940 DUKE STREET, ALEXANDRIA, VA, 22314, US

(73) Assignee: INERGY AUTO. SYST. RESEARCH (SOCIETE ANONYME), Bruxelles (BE)

(21) Appl. No.: 11/996,803

(22) PCT Filed: Jul. 26, 2006
(86) PCT No.: PCT/EP06/64699

§ 371 Date: Jul. 30, 2008

(30) Foreign Application Priority Data
Jul. 28, 2005 (FR) 05/08083

(51) Int. Cl. B23P 17/04

(52) U.S. Cl. 29/428

(57) ABSTRACT

Process for moulding at least one portion of a hollow plastic component, during which said portion is produced in a mould comprising a core and a cavity, by moulding in a space between by the core and the cavity, so that the moulded portion has no parting line at its surface intended to be in contact with a seal. Method of fastening such a component to the perimeter of an opening in a fuel tank.

The subject matter of the present invention relates to a process for moulding at least one portion of a hollow plastic component and for fastening it to a fuel tank.

Liquid and gas tanks used in industry or on board vehicles of various types must generally meet sealing and permeability standards with respect to the type of use for which they are designed and must also comply with environmental requirements. The permitted levels of emissions have become so low that losses due to leaks and permeability at the component/tank interfaces have become relatively more important in the total losses of the tank/accessories system.

To reduce the permeability at the interfaces between component and tank, a component may be fastened to the perimeter of an opening in a fuel tank by providing a portion of the component with a seal for sealing to the tank. However, for an injection-moulded component, said component (and in particular that portion of the component intended to carry the seal) is generally produced by means of a mould consisting of two parts or half-shells.

Moulding by means of a two-part mould therefore creates, in the region of contact between the seal and the surface of the groove, a parting line, and therefore two traces of the parting line in the junction region between the two half-shells of the mould. This parting line trace, even though minimal, may be the origin of a leakage path and therefore of a loss of sealing in the contact region between the seal and the groove, favouring an increase in evaporative losses at the component/tank interface.

The object of the present invention is to remedy this drawback thanks to a process for moulding a component that does not have a parting line on its surface in contact with a seal, thanks to the improved sealing this causes at the component/tank interface.

For this purpose, the invention relates to a process according to claim 1.

The term “hollow component” is understood to mean any part comprising an empty portion, such as for example a channel, connecting at least two ends of the component so that a fluid can flow between these ends.

In the process according to the invention, one portion of the component that is intended to bear a seal is produced in a mould comprising a cavity and a core. The cavity is a movable part constituting the external portion of the mould. The core is a pin which is also in general movable, at least partially, inside the mould. The cavity and the core preferably possess complementary portions in relief that are intended to give said portion of the component the desired shape. The two parts are generally made of a material capable of withstanding the processing conditions (temperature and pressure) of the plastic.

According to the invention, said component portion is moulded in a space in between the core and the cavity, preferably by injecting molten material under pressure. The relative positions of the core and of the cavity are adjusted so as to set the dimensions of the moulding space so as to obtain the desired thickness for that portion of the component to be moulded.

According to the invention, the process is carried out so that the moulded portion does not have a parting line at its surface intended to be in contact with the seal. The term “parting line” is understood to mean a relief on a surface created during moulding of a part. In a moulding process using a mould comprising a cavity and a core, one or other possibly consisting of several portions, this relief is generally created in a plane of contact between at least two portions of the core (in respect of a relief on an inner surface of the moulded component) or between at least two portions of the cavity (in respect of a relief on an outer surface of said component). Therefore, in the current process, said portion of the component is moulded by means of a core and a cavity which are not made up of several portions in the region in which the seal is intended to be placed.

In one particular mode of implementing the process, the moulded portion includes a groove intended for housing the seal. This, in that case, the outer surface of the groove has no parting line (since it is the one to be in contact with the seal). In general, the groove has a U-shaped profile.

Preferably, the groove includes a flexible portion, that is to say a portion or an extension of the groove (U-shaped profile) that has a flexible character. This flexible portion is obtained during moulding of the groove, either by varying the operating conditions of the moulding or by choosing a material which has suitable elastic properties after moulding, or by giving the moulded portion a thickness suitable for obtaining the desired elasticity, etc. . . . According to a preferred embodiment, the flexibility is increased by making the part discontinuous (for instance, by cutting it providing holes in it).

In one particular mode of implementation, the core is positioned in the cavity so as to create a space in between two complementary portions in relief of the core and of the cavity. The portion of the component that includes the groove is moulded in this space. Next, the core is removed from the cavity and the moulded portion that includes the groove is demoulded by moving the cavity so as to flex the flexible portion of the groove, the portion in relief on the cavity forming a reverse taper with respect to the flexible portion of the groove. In other words: the flexible portion of the groove must undergo flexure in order to be able to demould the moulded portion.

More preferably still, a groove comprising an annular seat and at least two flexible lips for retaining the seal is produced. These lips form a discontinuous wall on the moulded portion, more suitable for undergoing flexure. Better results are obtained if there are at least 4 lips, even preferably, at least 6 and even more preferably, at least 8. In fact, the sealing performances are increased if the flexible part is like a discontinuous annular lip (having cuts through it, which may finally define separate lips put evenly at the periphery of the groove).

The invention also relates to a device for moulding at least one portion of a hollow plastic component provided with a seal and comprising at least one movable cavity and at least one movable core, having two complementary portions in relief that bound a space for moulding said portion, the geometry of the moulding space being such that the portion in relief on the cavity constitutes a reverse taper with respect to said portion when the latter is being demoulded. The core and the cavity each also consist of a single part in the moulding space.

Furthermore, the invention relates to a hollow component for a fuel tank, which includes at least one portion provided with a seal, based on a plastic and including no parting line. The component generally provides fluid communication between the inside and the outside of the fuel tank. Preferably, the fluid is a gas (for example fuel vapour) or a liquid (for example fuel).

Advantageously but not limitingly, the component may be chosen from a delivery tube, an end-piece, a duct, a valve or a nozzle.

The term “fuel tank” is understood to mean a sealed container, of various shapes, generally sealed with respect to the outside and possibly equipped with various internal accessories or accessories passing through the wall of the enclosure. The tank may contain any type of liquid fuel. In particular, it may contain fuel for supplying internal combustion engines of motor vehicles, and in particular petrol and diesel.

Preferably, the seal is located in a groove containing no parting line on its surface intended to be in contact with the seal (the external one generally).

The seal makes it possible in general to achieve a sealed closure at the interface between the tank and that portion of the component which is fastened to the tank. The term “sealed closure” is understood to mean one able to prevent communication of liquid and/or gas between the component or the tank and the outside, under the normal temperature and pressure operating conditions of the tank.

Advantageously, the seal consists of an elastomer, preferably a fluoroelastomer as this material possesses good chemical resistance properties in contact with fuels in liquid or gaseous form.

The seal may be in various forms. For example, it may be a O-ring seal.

An O-ring seal of circular cross section has given good results.

According to the invention, the component essentially consists of plastic material, eventually containing usual additives like fillers, reinforcing particles or fibers etc.

The fuel tank according to the invention is also preferably made with a wall of plastic material.

The term “plastic” is understood to mean any synthetic polymer material, whether thermoplastic or thermosetting, which is in the solid state under ambient conditions, as well as blends of at least two of these materials. The intended polymers comprise both homopolymers and copolymers (especially binary or ternary copolymers). Examples of such copolymers are, non-limitingly, random copolymers, linear block copolymers and other block copolymers, and graft copolymers. Thermoplastic polymers, including thermoplastic elastomers, and blends thereof, are preferred.

Any type of thermoplastic polymer or copolymer, the melting point of which is below the decomposition temperature, is suitable. Thermoplastics having a melting range spread over at least 10 degrees Celsius are particularly suitable. Examples of such materials include those that exhibit polydispersion in their molecular weight.

One polymer often used is polyethylene. Excellent results have been obtained with high-density polyethylene (HIDPE).

In general, polyolefins, grafted polyolefins, thermoplastic polyesters, polyketones, polyamides and copolymers thereof are in general found in the component. It is advantageous to use POM (or polyoxymethylene) as material of the component.

Advantageously, the wall of the tank may have a multilayer structure comprising at least one layer of a thermoplastic and at least one layer made of a barrier material, that is to say a material, generally of polymeric nature, which possesses a very high level of impermeability to certain liquids and gases.

A barrier material may be incorporated into one of the layers of the wall of the tank, or a particular additional layer essentially made of a barrier material may be inserted inside the structure. Preferably, an additional layer consisting essentially of a barrier material is inserted inside the structure.

Non-limiting examples of barrier materials are the following: resins based on polyamides or copolyamides; ethylene/vinyl alcohol random copolymers (EVOH); and thermotropic liquid-crystal polymers, such as copolyesters of p-hydroxybenzoic acid and either 6-hydroxy-2-naphthoic acid or terephthalic acid, and 4,4′-biphenol (for example the copolyesters sold under the trade mark XYDAR®).

The component may be made of any material of suitable mechanical strength and chemical resistance (to fuels). According to the invention, it is made of a plastic. Any type of plastic may be suitable. Preferably, a plastic whose dimensional stability is good in a medium subjected to temperature variations of around a few tens of degrees Celsius is chosen. It is also preferable to choose a plastic whose dimensional stability is little affected by contact with the liquids and gases that are liable to be contained in the tank, and which is barely permeable thereto. Polyacetals, polyamides, polyesters and polyvinyl halides give good results. Very suitable plastics are polyacetals and, in particular, POM (or polyoxymethylene). Particularly preferably, the component is made of an injection-moulded plastic, that is to say one that has been formed by an injection moulding technique in which the material is injected under pressure into a mould.

Preferably, when the component is based on polyethylene, it is treated so as to reduce its permeability. For example, the treatment consists in sulphonating or fluorinating the component.

When the tank includes a barrier layer, the seal is preferably in contact with said barrier layer. The fact that the seal is in contact with the barrier layer of the wall of the tank makes it possible to reduce the gas or liquid leakage at the interface between the component and the tank.

The invention also relates to a method for fastening at least one portion of a hollow plastic component to the perimeter of an opening in a fuel tank. During this method, the portion of the component is produced according to a moulding process as described above.

Next, the seal is placed on the moulded portion, on its surface without parting line. In a particular embodiment, this seal may be a O-ring seal placed on a peripheral surface of the component, and preferably in a groove.

Next, the component is fastened to the tank so that the seal seals between the moulded portion and the perimeter of the opening in the tank. Any fastening technique known to those skilled in the art may be envisaged, such as for example the welding of means for fastening the component to the wall of the tank or the cooperation of these fastening means with other fastening means that are fastened to the perimeter of the opening in the tank.

The opening may be produced by any known technique, for example by cutting the wall of the tank.

The figures that follow are given for the purpose of illustrating the invention, without wishing to restrict the scope thereof.

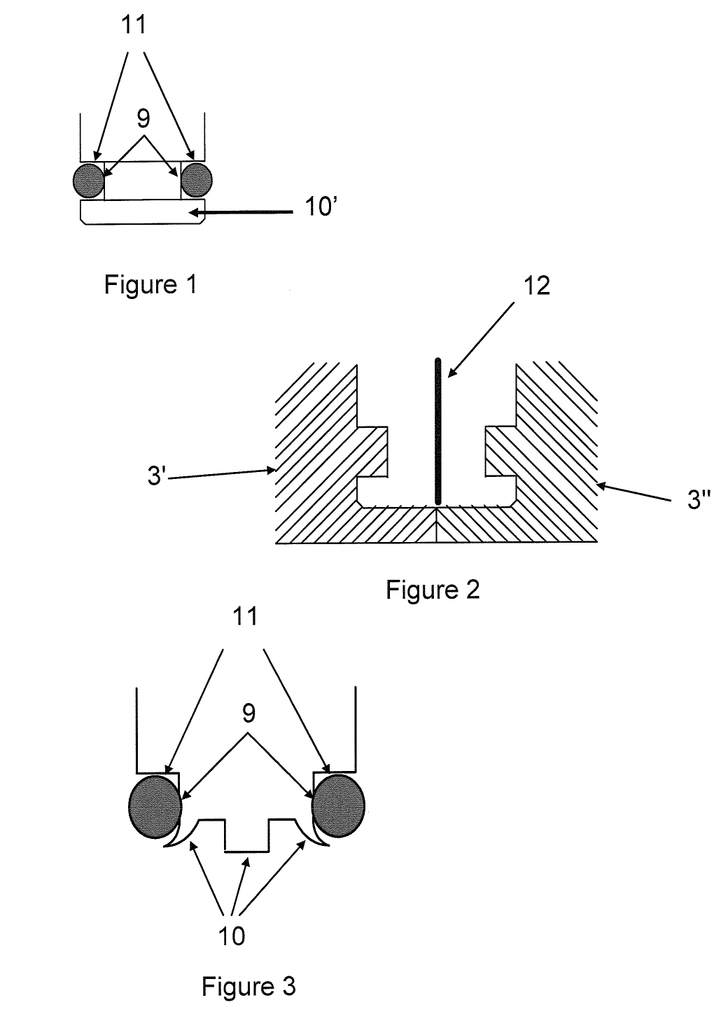

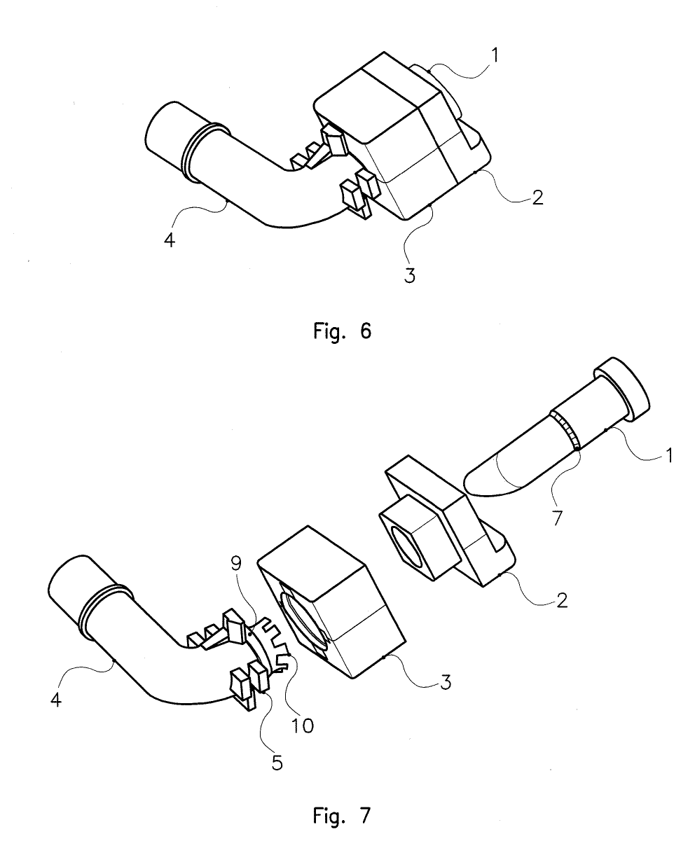

FIGS. 1 and 2 illustrate a component according to the prior art, while FIGS. 3 to 5 have the purpose of illustrating the principle of a preferred variant of the invention and FIGS. 6 to 8 a specific embodiment of such a variant.

FIG. 1 illustrates a component according to the prior art in which a seal (11) is placed in a groove on its periphery and is in contact with an annular seat (9) of the groove. The seal (11) is retained by a rigid portion (10′) of the component.

This component is produced by moulding it in a mould comprising several cavities as illustrated ((3′) and (3″)) in FIG. 2. In the joint plane between the cavities (3′) and (3″), a parting line (12), in relief on the annular seat (9), is created during moulding.

FIG. 3 illustrates an embodiment according to the invention in which the seal (11) lies in a groove, a portion of the wall of which consists of flexible lips (10). No parting line exists in the annular seat (9)—the region of contact with the seal (11).

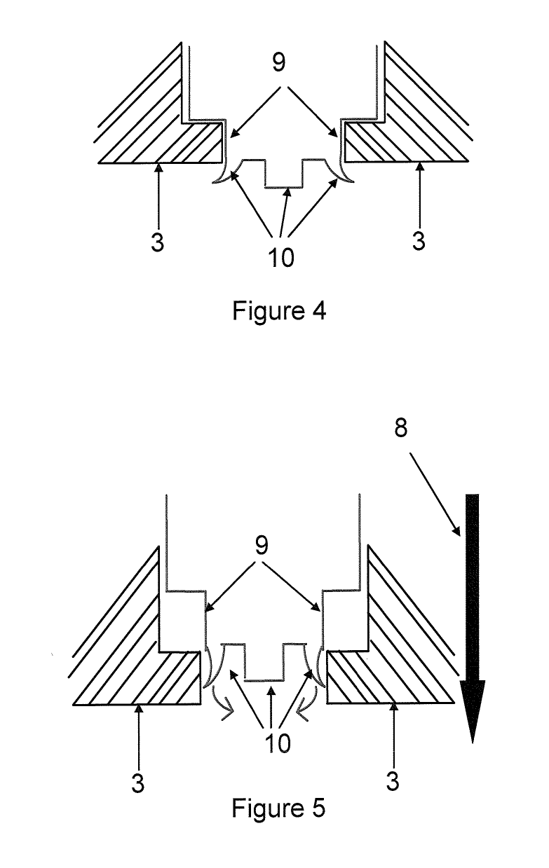

FIGS. 4 and 5 show two steps of the process for moulding a portion of a component which includes a groove for a seal (11) (as illustrated in FIG. 3). The cavity (3) is made of a single part. FIG. 5 shows the demoulding of the moulded portion by a movement of the cavity (3), such that the flexible lips (10) undergo flexure so as to be demoulded from the cavity (3).

FIG. 6 illustrates the arrangement of the portions of a mould during moulding of a portion of the component (4) which is intended to be fastened to a fuel tank. The part (1) corresponds to the movable core, whereas the parts (2) and (3) correspond to an intermediate part (2) and to a cavity (3) of the mould. The component (4) has its moulded portion (5) intended to be fastened to the tank still inside the mould formed by the parts (1), (2), (3).

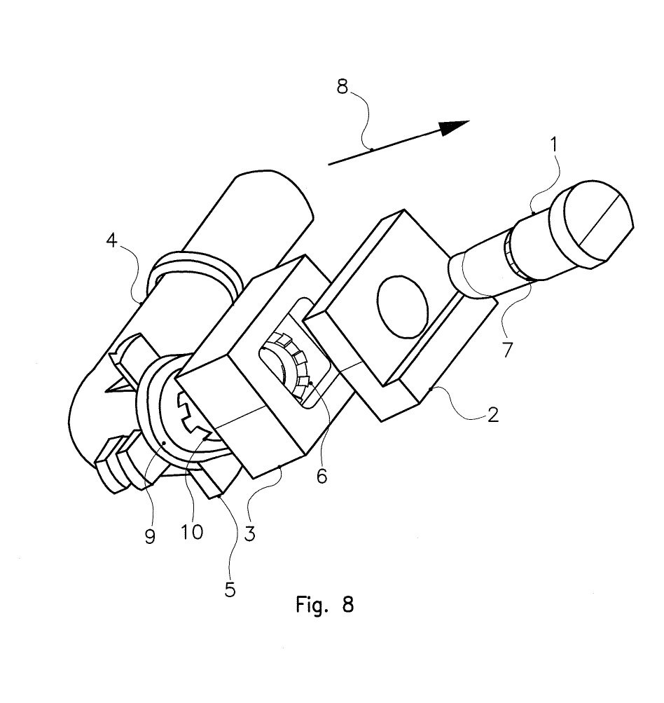

FIG. 7 shows an exploded view of these parts and also the component (4) having the moulded portion (5) that has been demoulded. The portion (5) includes a groove comprising an annular seat (9) and a set of flexible lips (10) whose purpose is to retain a seal (not shown).

FIG. 8 shows another exploded view in which the portions (6) and (7) in relief on the cavity (3) and on the core (1), respectively, have been shown. The arrow (8) indicates the direction of movement of the core (1), of the intermediate part (2) and of the cavity (3) during demoulding. The demoulding takes place in several steps: after injection of material into a space bounded by the core (1) and the cavity (3), the core (1) is removed from the cavity (3) in the direction indicated by the arrow (8), the intermediate part (2) is then moved in the same direction, and finally the moulded portion is demoulded by moving the cavity (3) in the same direction indicated by the arrow (8).

1. A process for fabricating and fastening at least one portion of a hollow plastic component having a surface intended to be in contact with a seal to the perimeter of an opening in a fuel tank, which method comprises the following steps:
the portion of the component is produced in a mould comprising a core and an cavity, by moulding in a space between by the core and the cavity, so that the surface of the moulding portion intended to be in contact with the seal has no parting line;
the seal is placed over the moulded portion, on said surface; and
the component is fastened to the tank so that the seal seals between the moulded portion and the perimeter of the opening in the tank.

2. The process according to claim 1, wherein the moulded portion includes a groove intended for housing the seal.

3. The process according to claim 2, wherein the groove includes a flexible portion.

4. The process according to claim 1, wherein:
the core is positioned in the cavity so as to create a space between two complementary portions in relief of the core and of the cavity;
the portion of the component that includes the groove is moulded in this space;
the core is removed from the cavity; and
the moulded portion that includes the groove is demoulded by moving the cavity so as to flex the flexible portion of the groove, the portion in relief on the cavity forming a reverse taper with respect to the flexible portion of the groove.

5. The process according to claim 2, wherein the groove comprises at least one annular seat and two retaining lips for the seal.

6. The process according to claim 2, wherein the groove comprises at least four retaining lips.

7. The process according to claim 1, wherein the component is selected from the group consisting of a delivery tube, an end-piece, a duct, a valve and a nozzle.
